(19) United States
(12) Patent Application Publication
(10) Pub. No.: US 2020/0048448 A1
(43) Pub. Date: Feb. 13, 2020

(54) VINYLIDENE CHLORIDE POLYMER COMPOSITIONS AND ARTICLES COMPRISING THE SAME

(71) Applicant: Dow Global Technologies LLC, Midland, MI (US)

(72) Inventors: Huiqing Zhang, Midland, MI (US); Douglas E. Beyer, Midland, MI (US); John A. Naumovitz, Midland, MI (US)

(21) Appl. No.: 15/738,866

(22) PCT Filed: Aug. 17, 2016
(86) PCT No.: PCT/US2016/047232

§ 371 Date: Dec. 21, 2017

Related U.S. Application Data
(60) Provisional application No. 62/212,078, filed on Aug. 31, 2015.

(51) Int. Cl. C08L 27/08; C08L 91/06; C08L 23/06; C08L 23/30; C08F 220/18; C08K 5/00

(52) U.S. Cl. CPC C08L 27/08; C08L 91/06; C08L 23/06; C08L 23/30; C08F 2220/1825; C08K 5/0016; C08L 2205/03; C08L 2203/16; C08F 220/18

(57) ABSTRACT

The present invention relates generally to vinylidene chloride polymer compositions. In one embodiment, a vinylidene chloride polymer composition comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; and (c) 0.2 to 7 weight percent of at least one additive comprising (i) at least one wax in an amount of from 0.01 to 2 weight percent based on the total weight of the polymer composition, (ii) at least one polyethylene having a density greater than 0.940 g/cm3 in an amount of from 0.1 to 5 weight percent based on the total weight of the polymer composition, or combinations thereof.

### FIELD

The disclosure relates to vinylidene chloride polymer compositions, and to articles comprising the same.

### INTRODUCTION

Vinylidene chloride polymers are known to be useful in the fabrication of packaging films for oxygen-sensitive materials such as food products. Various processing aids and lubricants have been used to improve the thermal stability and extrusion performance of vinylidene chloride polymer and copolymers. Such improvements are often noted as improved metal release and lower melt temperature. Typical processing aids and lubricants include materials such as wax/oils, polyolefins, oxidized wax/polyolefins, metal salts of organic acids with long alkyl chain, silicon, and fluoropolymers. However, such lubricants potentially affect the feeding and extrusion rate. While some acid scavengers can slow down the degradation process of vinylidene chloride polymers or copolymers, they alone are not efficient in reducing the metal adhesion and viscous heating. Acrylic processing aids have also used to improve extrusion performance. While such processing aids do not have a significant adverse effect on extrusion rate, their improvements on metal release and lower melt temperatures are not fully satisfactory.

New vinylidene chloride polymer compositions which exhibit excellent metal release, low shear heating, low melt temperature, and/or improved thermal stability and extrusion performance, while also exhibiting acceptable barrier and/or optical performance, would be beneficial.

### SUMMARY

The present invention provides polyvinylidene chloride polymer compositions which advantageously provide one or more desirable properties. For example, in some embodiments, the polyvinylidene chloride polymer compositions can advantageously provide a combination of desirable properties (e.g., metal release, low shear heating, low melt temperature, improved thermal stability and extrusion at high extrusion rates, barrier properties, and/or optical properties), while not being prone to segregation during shipment and handling.

In one aspect, the present invention provides a vinylidene chloride polymer composition that comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; and (c) at least one additive comprising (i) at least one wax in an amount of from 0.01 to 2 weight percent based on the total weight of the polymer composition, (ii) at least one polyethylene having a density greater than 0.940 g/cm³ in an amount of from 0.1 to 5 weight percent based on the total weight of the polymer composition, or combinations thereof.

In another aspect, the present invention provides a vinylidene chloride polymer composition that comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; (c) 0.3 to 5 weight percent of a plasticizer based on the total weight of the polymer composition; (d) at least one wax in an amount of from 0.01 to 2 weight percent based on the total weight of the polymer composition; and (e) at least one polyethylene having a density greater than 0.940 g/cm³ in an amount of from 0.1 to 5 weight percent based on the total weight of the polymer composition.

These and other embodiments are described in more detail in the Detailed Description.

### DETAILED DESCRIPTION

Unless specified otherwise herein, percentages are weight percentages (wt %) and temperatures are in ° C.

The term “composition,” as used herein, includes a mixture of materials which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term “polymer molecular weight” is used herein to designate the weight average molecular weight in Daltons. It is measured by size exclusion chromatography using polystyrene calibration.

The term “plasticizer” as used herein refers to a substance or material incorporated into a polymer composition to increase the flexibility, pliability or softness of the polymer or a final product made from it, for instance a film or fiber. Usually, a plasticizer lowers the glass transition temperature of the plastic, making it softer. However, strength and hardness often decrease as a result of added plasticizer.

Embodiments of the present invention generally relate to vinylidene chloride polymer compositions. In one embodiment, a vinylidene chloride polymer composition comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; and (c) 0.2 to 7 weight percent of at least one additive comprising (i) at least one wax in an amount of from 0.01 to 2 weight percent based on the total weight of the polymer composition, (ii) at least one polyethylene having a density greater than 0.940 g/cm3 in an amount of from 0.1 to 5 weight percent based on the total weight of the polymer composition, or combinations thereof.

In some embodiments, the monoethylenically unsaturated monomer comprises vinyl chloride, alkyl acrylate, alkyl methacrylate, acrylic acid, methacrylic acid, itaconic acid, acrylonitrile, or methacrylonitrile, and combinations thereof. The monoethylenically unsaturated monomer, in some embodiments, comprises methyl acrylate.

In some embodiments, the acrylic polymer comprises monomer units derived from at least one of alkyl acrylate, alkyl methacrylate, styrenic monomer, or combinations thereof. In some embodiments, the acrylic polymer comprises monomer units derived from butyl acrylate, butyl methacrylate, and/or methyl methacrylate. The vinylidene chloride polymer composition, in some embodiments, comprises 0.5 to 3 weight percent of the acrylic polymer based on the total weight of the polymer composition.

In some embodiments where the at least one additive comprises wax, the wax can be a paraffin wax such as a Fischer-Tropsch paraffin wax. In some embodiments, the wax has a molecular weight at least 500 and a melting point at least 70° C. The wax is oxidized in some embodiments. In some embodiments where the at least one additive comprises polyethylene, the polyethylene has a density greater than 0.940 g/cm³. In some embodiments, the polyethylene is oxidized. In some embodiments, the total amount of wax and polyethylene comprises 0.01 to 5 weight percent of the total weight of the polymer composition, or 0.2 to 7 weight percent in other embodiments. The total amount of wax and polyethylene, in some embodiments, comprises 0.03 to 2 weight percent of the total weight of the polymer composition. In some embodiments, the wax, polyolefin, or combination thereof is present in an amount of 0.2 to 2 weight percent of the vinylidene chloride polymer composition. The total amount of wax and polyethylene comprises 0.05 to 1 weight percent of the total weight of the polymer composition in some embodiments. The wax, polyolefin, or combination thereof, in some embodiments, is present in an amount of 0.2 to 1 weight percent of the vinylidene chloride polymer composition. The polymer composition, in some embodiments, comprises 0.01 to 1 weight percent of the at least one wax and 0.1 to 1 weight percent of the at least one polyethylene.

In some embodiments, the vinylidene chloride polymer composition further comprises at least one plasticizer. The at least one plasticizer, in some embodiments, comprises epoxidized soybean oil, epoxidized linseed oil, an epoxidized ester, dibutyl sebacate, acetyl tributyl citrate, other citrate esters, other polymeric or high molecular weight ester oils, or combinations thereof. In some embodiments, the polymer composition comprises 0.1 to 10 weight percent of the plasticizer, or 0.3 to 5 weight percent of the plasticizer, or 0.5 to 3 weight percent of the plasticizer.

In another embodiment, a vinylidene chloride polymer composition of the present invention comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; (c) 0.3 to 5 weight percent of a plasticizer based on the total weight of the polymer composition; (d) at least one wax in an amount of from 0.01 to 2 weight percent based on the total weight of the polymer composition; and (e) at least one polyethylene having a density greater than 0.940 g/cm³ in an amount of from 0.1 to 5 weight percent based on the total weight of the polymer composition.

A vinylidene chloride polymer composition of the present invention, in another embodiment, comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; (c) 0.3 to 5 weight percent of a plasticizer based on the total weight of the polymer composition; (d) at least one wax in an amount of from 0.01 to 2 weight percent based on the total weight of the polymer composition; and (e) at least one polyethylene having a density greater than 0.940 g/cm³ in an amount of from 0.1 to 2 weight percent based on the total weight of the polymer composition.

In another embodiment, a vinylidene chloride polymer composition of the present invention comprises (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.5 to 3 weight percent of an acrylic polymer based on the total weight of the polymer composition; (c) 0.5 to 3 weight percent of a plasticizer based on the total weight of the polymer composition; (d) at least one wax in an amount of from 0.03 to 1 weight percent based on the total weight of the polymer composition; and (e) at least one polyethylene having a density greater than 0.940 g/cm³ in an amount of from 0.1 to 1 weight percent based on the total weight of the polymer composition.

In some embodiments, the vinylidene chloride polymer can be in the form of particles, and one or more of the other components (e.g., the acrylic polymer, the wax, and/or the polyethylene) can be coagulated on the surface of the vinylidene chloride polymer particles.

The vinylidene chloride polymer composition, in some embodiments, can further comprise other additives such as heat or thermal stabilizers, light stabilizers, antiblocks, acid scavengers, pigments, processing aids, lubricants, fillers, and/or antioxidants, and combinations thereof.

Embodiments of the present invention also relate to articles formed from any of the vinylidene chloride polymer compositions of the present invention. In some embodiments, the article can be a film or a multilayer film. Some embodiments relate to a package comprising a film formed from any of the vinylidene chloride polymer compositions of the present invention. In some embodiments, the package comprises a food package and can further comprise a food item.

### Vinylidene Chloride Polymer

As used herein, the term “vinylidene chloride polymer” encompasses copolymers and interpolymers comprising vinylidene chloride, wherein the major component is vinylidene chloride and the remainder is one or more monoethylenically unsaturated comonomer copolymerizable therewith. For vinylidene chloride polymers, an effective amount of polymerized vinylidene chloride monomer is generally in the range of from 60 to 100 percent by weight of polymer. The amount of monoethylenically unsaturated comonomer copolymerizable therewith is generally in the range of 1 to 40 weight percent by weight of polymer. Monoethylenically unsaturated monomers which can be employed in the practice of the present invention for preparing the vinylidene chloride polymers include vinyl chloride, alkyl acrylates, alkyl methacrylates, acrylic acid, methacrylic acid, itaconic acid, acrylonitrile, methacrylonitrile, and combinations thereof. Preferred monoethylenically unsaturated monomers include acrylonitrile, methacrylonitrile, alkyl acrylates, alkyl methacrylates, and combinations thereof. More preferred monoethylenically unsaturated monomers include acrylonitrile, methacrylonitrile, and the alkyl acrylates and alkyl methacrylates having from 1 to 8 carbon atoms per alkyl group. Most preferably, the alkyl acrylates and alkyl methacrylates are methyl acrylates, ethyl acrylates, butyl acrylates, and/or methyl methacrylates. In some embodiments, the monoethylenically unsaturated monomer is methyl acrylate.

In some embodiments, the vinylidene chloride polymer comprises an interpolymer formed from the copolymerization of vinylidene chloride with methyl acrylate. In some such embodiments, the vinylidene chloride polymer is formed from a monomer mixture comprising 80 to 99 weight percent vinylidene chloride and 1 to 20 weight percent of methyl acrylate. In some such embodiments, the vinylidene chloride polymer is formed from a monomer mixture comprising 84 to 98 weight percent vinylidene chloride and 2 to 16 weight percent of methyl acrylate. In some such embodiments, the vinylidene chloride polymer is formed from a monomer mixture comprising 90 to 97 weight percent vinylidene chloride and 3 to 10 weight percent of methyl acrylate. Weight percent is based on total weight of the vinylidene chloride polymer.

Vinylidene chloride polymers are known and are commercially available. Processes for preparing them, such as by emulsion or suspension polymerization process, are also familiar to persons of ordinary skill in the art. See, for example, U.S. Pat. Nos. 2,558,728; 3,007,903 and 3,879,359.

One exemplary method for the preparation of vinylidene chloride polymers is a batch suspension process. In such a process, organic components including vinylidene chloride, monoethylenically unsaturated comonomer(s), and initiator are added to the reactor. Aqueous components including deionized water and suspending agent are also added to the reactor. Other optional components can include organic components such as plasticizers or antioxidants and aqueous components such as buffers or metal chelating agents. Mixing is applied to the batch to create a suspension. The specific order of addition, mixing and proportions of organic and aqueous phases are variable, but are generally completed in a manner to insure that all organic components are uniformly dispersed and upon mixing, an organic in aqueous suspension is created.

After the reaction mixture is loaded, it is heated to initiate the polymerization reaction. Polymerization temperatures are generally in the range of 30 to 90° C. Reaction is normally allowed to proceed to a conversion of monomer to polymer of between 70 and 99%. At this point the polymerization mixture is in the form of polymer particles, generally 150 to 350 micron volume average particle size, suspended in the aqueous phase. Once the polymerization is completed to the desired conversion, the reactor may be vented. Additional heat and vacuum may be applied to assist in removal of residual monomers. While in this slurry state, additional components including, for example, plasticizers, stabilizers and processing aids, can be added.

After the removal of residual monomers and addition of further additives, the resin slurry is dewatered and dried. In its final form, the vinylidene chloride polymer is a dry powder comprising spherical particles that are in the range of 150 to 350 microns (volume median particle size). The dry resin can be optionally blended with other additives in a post-blending operation.

In some embodiments, a vinylidene chloride polymer composition comprises 75 to 99 weight percent vinylidene chloride polymer based on the weight of the polymer composition. A vinylidene chloride polymer composition, in some embodiments, comprises 85 to 99 weight percent vinylidene chloride polymer based on the weight of the polymer composition. A vinylidene chloride polymer composition comprises 90 to 99 weight percent vinylidene chloride polymer based on the weight of the polymer composition in some embodiments. In some embodiments, a vinylidene chloride polymer composition comprises 93 to 99 weight percent vinylidene chloride polymer based on the weight of the polymer composition. A vinylidene chloride polymer composition, in some embodiments, comprises 75 to 98 weight percent, or 85 to 98 weight percent, or 90 to 98 weight percent, or 93 to 98 weight percent vinylidene chloride polymer.

### Acrylic Polymer

Embodiments of vinylidene chloride polymer compositions of the present invention comprise an acrylic polymer. In some embodiments, the acrylic polymer is a methacrylic polymer. The acrylic polymer can be prepared from monomers comprising at least one alkyl acrylate (e.g., butyl acrylate) or alkyl methacrylate (e.g., butyl methacrylate, methyl methacrylate) monomer, or a combination thereof, optionally with at least one styrenic monomer or a combination thereof; that is, having mer units from the alkyl acrylate and/or the alkyl methacrylate monomer or monomers and optionally from styrenic monomer or monomers.

In some embodiments, the acrylic polymer comprises methyl methacrylate, in an amount of at least 30, or at least 40, or at least 50 wt %, and at least one additional methacrylic or acrylic alkyl ester or styrenic monomer or combinations thereof, or at least one additional methacrylic or acrylic alkyl ester. The alkyl groups of the alkyl acrylate and methacrylate monomers have at least 1 carbon atom, to at most 16 carbon atoms, or at most 8 carbon atoms, or at most 4 carbon atoms.

In some embodiments, the acrylic polymer comprises methacrylate and acrylate ester monomers, for polymerization with methyl methacrylate including such monomers as methyl acrylate, ethyl acrylate, butyl acrylate, ethyl methacrylate, butyl methacrylate, styrenic monomers such as styrene, alpha-methyl styrene, para-methyl styrene, para-tert-butyl styrene, and combinations thereof.

In some embodiments, the acrylic polymer has a polymer molecular weight of at least 100,000, or at least 150,000, or at least 200,000, to at most 4,000,000, or at most 700,000, or at most 500,000 Daltons. In some embodiments, a plurality of acrylic polymers can be provided having a variety of molecular weights (e.g., a low molecular weight fraction and a high molecular weight fraction).

In some embodiments, the acrylic polymer is a polymer comprising an acrylate monomer, a methacrylate monomer, a styrene monomer, and combinations thereof. Nonlimiting examples of suitable acrylate polymer include methyl acrylate, butyl acrylate, methyl methacrylate, butyl methacrylate and styrene.

In some embodiments, the acrylate polymer is an interpolymer of methyl methacrylate, butyl methacrylate and butyl acrylate.

The acrylic polymers may be produced in an emulsion polymerization process as known to those of skill in the art. Such processes can also include a continuous addition (con-add) component where monomers and initiators may be added throughout portions of the polymerization. Single or multiple con-adds may be employed, creating a polymer particle that is of a single composition or layers of multiple compositions or molecular weights.

The amount of acrylic polymer present in the composition, in various embodiments, is from 0.1 wt %, or 0.3 wt %, or 0.5 wt %, to 3 wt %, or 5 wt %, or 10 wt %. For example, in some embodiments, the acrylic polymer is present in an amount from 0.1 to 10 wt %, or from 0.3 to 5 wt %, or from 0.5 to 3 wt %. Weight percent is based on total weight of the composition.

The acrylic polymer can be spray dried and dry blended with the vinylidene chloride polymer. The acrylic polymer can also be provided in the form of a latex and added to an aqueous slurry with the vinylidene chloride polymer. Acrylic polymers in the form of a latex, as well as processes for preparing polymer latexes, are known. Additional description regarding acrylic polymers in the form of a latex can be found in U.S. Pat. No. 6,627,769.

One example of a commercially available acrylic polymer in latex form is Plastistrength L-1000, which is commercially available from Arkema Group.

Wax and/or Polyolefin

Embodiments of vinylidene chloride polymer compositions of the present invention comprise a wax, a polyethylene, or a combination thereof. In some embodiments, the wax and/or polyethylene can be dry blended with the vinylidene chloride polymer and other components of the composition. In some embodiments, the wax and/or polyethylene can be dry blended after an acrylic polymer is coagulated on the surface of the vinylidene chloride polymer particles while in other embodiments, the acrylic polymer and the wax and/or polyethylene can each be dry blended. In other embodiments, the wax and/or polyethylene can be coagulated on the surface of vinylidene chloride polymer particles. The inclusion of wax and/or polyolefin in the compositions is believed to provide desirable processing performance (e.g., low metal adhesion, low melt temperature, good extrusion performance) as well as desirable film properties.

In some embodiments, the polymer composition comprises a wax. The wax is oxidized in some embodiments, and not oxidized in others. Examples of waxes that can be included in embodiments of the present invention include paraffin wax, microcrystalline wax, and modified paraffin wax such as Fischer-Tropsch wax. In some embodiments, the wax comprises paraffin wax. In some embodiments, the wax has a molecular weight of at least 400 and a melting point of at least 50° C., or a molecular weight of at least 500 and a melting point of at least 70° C., or a molecular weight of at least 600 and a melting point of at least 90° C.

Multiple waxes can be included in some embodiments of compositions of the present invention.

In some embodiments where the composition comprises a wax, the wax is provided as a powder and can be dry blended.

In other embodiments where the composition comprises a wax, the wax can be provided as a dispersion. In such embodiments, the dispersion can comprise a surfactant. In some embodiments, the dispersion is made with a non-ionic surfactant to provide a non-ionic dispersion, while in other embodiments, the dispersion is made with an anionic dispersion to provide an anionic dispersion.

The total amount of wax present in the composition, in various embodiments where wax is a component, is from 0.01 wt %, or 0.03 wt %, or 0.05 wt %, to 1 wt %, or 2 wt %, or 5 wt %. For example, in some embodiments, wax is present in an amount from 0.01 to 5 wt %, or from 0.03 to 2 wt %, or from 0.05 to 1 wt %. Weight percent is based on total weight of the composition.

One example of a commercially available modified paraffin wax that can be used in some embodiments is Vestowax SH-105, which is a non-functionalized Fischer-Tropsch hard paraffin wax commercially available from Evonik Corporation. Some modified paraffin waxes are commercially available as powders but can be made into dispersions using techniques known to those of skill in the art.

In some embodiments, the composition comprises at least one polyolefin such as polyethylene. The polyolefin is oxidized in some embodiments, and not oxidized in others. One example of a polyolefin that can be used in some embodiments is high density polyethylene (HDPE). The HDPE has a density of greater than 0.940 g/cm³. In some embodiments, the polyethylene has a molecular weight of 1,000 to 10,000 g/mol.

Multiple polyolefins can be included in some embodiments of compositions of the present invention.

In embodiments where the composition comprises a polyolefin, the polyolefin is provided as a dispersion. In such embodiments, the dispersion can comprise a surfactant. In some embodiments, the dispersion is made with a non-ionic surfactant to provide a non-ionic dispersion, while in other embodiments, the dispersion is made with an anionic surfactant to provide an anionic dispersion. In some embodiments, the polyolefin can be a masterbatch of high molecular weight, functionalized poly(dimethylsiloxane) (PDMS) dispersed in a high density polyethylene.

The total amount of polyolefin present in the composition, in various embodiments comprising at least one polyolefin, is from 0.1 wt %, or 0.2 wt %, or 0.3 wt %, to 1 wt %, or 2 wt %, or 5 wt %. For example, in some embodiments, one or more polyolefins are present in an amount from 0.1 to 5 wt %, or from 0.2 to 2 wt %, or from 0.3 to 1 wt %. Weight percent is based on total weight of the composition.

One example of a commercially available polyolefin that can be used in some embodiments is A-C 316A high density oxidized polyethylene, which is commercially available from Honeywell Corporation. Another commercially available polyolefin that can be used in some embodiments is Alathon H5057 high density polyethylene, which is commercially available from Equistar. While some such polyolefins may be commercially available as a powder, if desired, such powders can be made into dispersions using techniques known to those of skill in the art. A commercially available polyolefin dispersion that can be used in some embodiments is Michem Emulsion 61335, which is an anionic high density polyethylene dispersion (anionic surfactant) commercially available from Michelman, Inc. Another commercially available polyolefin dispersion that can be used in some embodiments is Michem Emulsion 98635, which is a non-ionic high density dispersion (non-ionic surfactant) commercially available from Michelman, Inc.

In some embodiments, compositions of the present invention can comprise at least one wax and at least on polyolefin. In such embodiments, the at least one wax and the at least one polyolefin can be any of those disclosed herein. The total amount of wax and polyolefin present in such embodiments is from 0.01 wt %, or 0.03 wt %, or 0.05 wt %, or 0.1 wt %, or 0.2 wt %, to 1 wt %, or 2 wt %, or 5 wt %, or 7 wt %. For example, in some embodiments, the wax and polyoefin(s) are present in an amount from 0.01 to 5 wt %, or from 0.03 to 2 wt %, or from 0.05 to 1 wt %, or from 0.2 to 7 wt %, or from 0.2 to 5 wt %, or from 0.2 to 2 wt %, or from 0.2 to 1 wt %. Weight percent is based on total weight of the composition.

The at least one wax and/or polyolefin may be incorporated by dry blending the wax and/or polyolefin(s) with the vinylidene chloride polymer particles. Another alternative technique is to add the wax and/or polyolefin(s) in the form of a dispersion to an aqueous slurry of vinylidene chloride polymer particles, and then add a coagulant to coagulate the wax and/or polyolefin(s) on the surfaces of the vinylidene chloride polymer particles. Further information on the coagulation process is provided herein.

### Plasticizer

In some embodiments, vinylidene chloride polymer compositions of the present invention can further comprise a plasticizer.

In embodiments comprising a plasticizer, the plasticizer has a molecular weight of a least 300 Daltons. In various embodiments, the plasticizer has a molecular weight of at least 500 Daltons, or 700 Daltons, or 800 Daltons to 2,000 Daltons, or 5,000 Daltons, or 10,000 Daltons.

In some embodiments, the plasticizer is an epoxy plasticizer, that is, a plasticizer having at least one epoxy group per molecule. Nonlimiting examples of suitable epoxy plasticizers include epoxidized soybean oil, epoxidized linseed oil, epoxidized sunflower oil, epoxidized vegetable oil, epoxidized ester, and combinations thereof.

In some embodiments, the plasticizer comprises an ester plasticizer, such as an aliphatic ester plasticizer. Nonlimiting examples of suitable ester plasticizers include dibutyl sebacate, acetyl tributyl citrate (ATBC), other citrate esters, other polymeric or high molecular weight ester oils, advantageously having a molecular weight of at least about 300 and combinations thereof.

In some embodiments, vinylidene chloride polymer compositions of the present invention comprise multiple plasticizers.

The total amount of plasticizer in embodiments where one or more plasticizers are present is from 0.1 wt %, or 0.3 wt %, or 0.5 wt %, to 3 wt %, or 5 wt %, or 10 wt %. For example, in some embodiments, the plasticizer(s) is present in an amount from 0.1 to 10 wt %, or from 0.3 to 5 wt %, or from 0.5 to 3 wt %. Weight percent is based on total weight of the composition.

### Additives

In some embodiments, vinylidene chloride polymer compositions of the present invention may optionally include one or more additives. Nonlimiting examples of suitable additives include UV or light stabilizers, heat or thermal stabilizers, acid scavengers (e.g., tetrasodium pyrophosphate (TSPP), calcium oxide, calcium hydroxide, magnesium oxide, magnesium hydroxide, magnesium aluminum hydroxide carbonate (hydrotalcite, DHT-4A)), pigments, processing aids, lubricants (e.g., calcium stearate, calcium stearyl lactylate), fillers, antioxidants, slip agents and antiblocks (e.g., erucamide, stearamide, calcium carbonate, talc), fluoropolymers, silicon polymers, and combinations thereof.

The total amount of additives in embodiments where one or more additives are present is from 0.01 wt %, or 0.03 wt %, or 0.05 wt %, to 1 wt %, or 3 wt %, or 5 wt %. For example, in some embodiments, the additive(s) are present in an amount from 0.01 to 1 wt %, or from 0.03 to 3 wt %, or from 0.05 to 5 wt %. Weight percent is based on total weight of the composition.

Various combinations of components and relative amounts are contemplated as embodiments of the present invention.

For example, in one embodiment, a vinylidene chloride polymer composition of the present invention comprises (a) a vinylidene chloride polymer formed from a monomer mixture comprising from 60 to 99 weight percent vinylidene chloride monomer and from 40 to 1 weight percent of methyl acrylate monomer copolymerizable therewith; (b) 0.3 to 5 weight percent of an acrylic polymer (e.g., methyl acrylate polymer) based on the total weight of the polymer composition; (c) 0.3 to 5 weight percent of a plasticizer based on the total weight of the polymer composition; (d) at least one paraffin wax in an amount of from 0.01 to 2 weight percent based on the total weight of the polymer composition; and (e) at least one polyethylene having a density greater than 0.940 g/cm³ in an amount of from 0.1 to 5 weight percent based on the total weight of the polymer composition.

A vinylidene chloride polymer composition of the present invention, in another embodiment, comprises (a) a vinylidene chloride polymer formed from a monomer mixture comprising from 60 to 99 weight percent vinylidene chloride monomer and from 40 to 1 weight percent of a methyl acrylate monomer copolymerizable therewith; (b) 0.3 to 5 weight percent of an acrylic polymer (e.g., a methyl acrylate polymer) based on the total weight of the polymer composition; (c) 0.3 to 5 weight percent of a plasticizer based on the total weight of the polymer composition; (d) at least one paraffin wax in an amount of from 0.01 to 2 weight percent based on the total weight of the polymer composition; and (e) at least one polyethylene having a density greater than 0.940 g/cm³ in an amount of from 0.1 to 2 weight percent based on the total weight of the polymer composition.

In another embodiment, a vinylidene chloride polymer composition of the present invention comprises (a) a vinylidene chloride polymer formed from a monomer mixture comprising from 60 to 99 weight percent vinylidene chloride monomer and from 40 to 1 weight percent of a methyl acrylate monomer copolymerizable therewith; (b) 0.5 to 3 weight percent of a methyl acrylate polymer based on the total weight of the polymer composition; (c) 0.5 to 3 weight percent of a plasticizer based on the total weight of the polymer composition; (d) at least one paraffin wax in an amount of from 0.03 to 1 weight percent based on the total weight of the polymer composition; and (e) at least one polyethylene having a density greater than 0.940 g/cm³ in an amount of from 0.1 to 1 weight percent based on the total weight of the polymer composition.

Some embodiments of vinylidene chloride polymer compositions can be prepared by dry blending using techniques known to those of skill in the art based on the teachings herein. In some embodiments, acrylic polymer, wax, and/or polyethylene can be added to a polymer slurry after monomer has been stripped from the slurry. In some embodiments, a polymer can be reslurried after formation of the polymer, and the acrylic polymer, wax, and/or polyethylene can be added at that time.

In some embodiments where the acrylic polymer, wax, and/or polyolefin are coagulated on the surface of the vinylidene chloride particles, the composition can be prepared as follows. An aqueous dispersion of vinylidene chloride polymer particles is formed by (1) adding water to a vinylidene chloride polymer that has been dewatered but not dried, or to dried vinylidene chloride polymer, and (2) stirring the mixture to form an aqueous dispersion of vinylidene chloride polymer particles. A dispersion (or dispersions) comprising wax, oxidized wax, polyolefin, and/or oxidized polyolefin is added to the dispersion of vinylidene chloride polymer particles. The acrylic polymer is added as a latex to the aqueous dispersion of vinylidene chloride polymer particles before, after, or at the same time as the other wax/polyolefin dispersion. The wax/polyolefin dispersion and/or latex acrylic polymer can be added either to the polymerization reactor before transferring the aqueous dispersion of vinylidene chloride polymer particles to the monomer stripper vessel, or to the monomer stripper vessel as the vinylidene chloride polymer particles dispersion is being heated to a temperature sufficient to vacuum-strip the residual monomer, or to the polymerization reactor or monomer stripper vessel after residual monomers are removed.

After adding the latex acrylic polymer and the dispersion of wax/polyolefin to the aqueous dispersion of vinylidene chloride polymer particles, the latex acrylic polymer and wax/polyolefin dispersion are coagulated on the surface of the polymer particles to coat the particles. The coagulation of the latex acrylic polymer and wax/polyolefin dispersion on the surface of the polymer particles can be done by mechanical means or by adding a chemical coagulant to the aqueous dispersion of vinylidene chloride polymer particles. The dispersion of coated vinylidene chloride polymer particles is then cooled down, unloaded and dewatered and the coated vinylidene chloride polymer particles are collected and further dried.

The coagulants which can be employed in the practice of the present invention are well known in the latex art and include the water soluble inorganic salts of metallic ions. Among the preferred materials are sodium chloride, sodium phosphate, calcium chloride, magnesium chloride, and aluminum sulfate. Acid coagulation (e.g., with hydrochloric acid) can also be used in some embodiments. The coagulant is usually employed in an amount of from 0.5 to 20 percent by weight, although the minimum concentration required to coagulate the latex and wax/polyolefin dispersion is to be preferred. Other techniques known to those of skill in the art for coagulating latexes can also be used based on the teachings herein.

Other additives which impart desirable properties can be incorporated by any suitable technique, for example, by dry blending. Examples of such additives are described above.

### Articles

The vinylidene chloride polymer compositions of the present invention can be melt-processed and extruded into any suitable final product, for example, a variety of films or other articles. As is well known in the art, the films and articles are fabricated with conventional coextrusion; for example, feedblock coextrusion, multimanifold die coextrusion, or combinations of the two; injection molding; co-injection molding; extrusion molding; casting; blowing; blow molding; calendering; and laminating.

Exemplary articles include blown and cast, mono and multilayer films; rigid and flexible containers; rigid and foam sheet; tubes; pipes; rods; fibers; and various profiles. Lamination techniques are particularly suited to produce multi-ply sheets. As is known in the art, specific laminating techniques include fusion; that is, whereby self-sustaining lamina are bonded together by applications of heat and pressure; wet-combining, that is, whereby two or more plies are laminated using a tie-coat adhesive, which is applied wet, the liquid driven off, and in one continuous process combining the plies by subsequent pressure lamination; or by heat reactivation, that is, combining a precoated film with another film by heating, and reactivating the precoat adhesive so that it becomes receptive to bonding after subsequent pressure laminating.

The vinylidene chloride polymer compositions of the present invention are particularly suited for fabrication into flexible and rigid containers both in monolayer and multilayer structures used for the preservation of food, drink, medicine and other perishables. Such containers should have good mechanical properties, as well as low gas permeabilities to, for example, oxygen, carbon dioxide, water vapor, odor bodies or flavor bodies, hydrocarbons or agricultural chemicals.

Some embodiments of the invention will now be described in detail in the following Examples.

### EXAMPLES

Materials

The materials used in the comparative and inventive examples are provided in Table 1:

TABLE 1

| Component | Specification |
|---|---|
| PVDC-MA Copolymer 1 | Poly(vinylidene chloride-co-methyl acrylate) |
| | copolymer with 8.5% by weight methyl acrylate |
| | and 2% plasticizer (epoxidized soybean oil) |
| PVDC-MA Copolymer 2 | Poly(vinylidene chloride-co-methyl acrylate) |
| | copolymer prepared by the process described in |
| | Example 1 of U.S. Pat. No. 6,627,769. |
| | Specifically, 2% of an acrylic polymer as a latex |
| | (Plastistrength L-1000 from Arkema Group) is added |
| | to a slurry of PVDC-MA Copolymer 1, and then |
| | coagulated onto the surface of the PVDC-MA |
| | polymer particles. |
| Acrylic Polymer | Polymer with monomer unit of methyl methacrylate- |
| | butyl acrylate-butyl methacrylate as a latex or spray |
| | dried. |
| | Plastistrength L-1000 from Arkema Group |
| Wax | Non-functionalized, Fischer-Tropsch hard paraffin |
| | wax |
| | Vestowax SH-105 from Evonik Corporation |
| Low Density Polyethylene | Low density polyethylene having a density of |
| (LDPE) | 0.91 g/cm³ |
| | A-C 617A from Honeywell Corporation |
| High Density Polyethylene | High density polyethylene having a density of 0.948 g/cm³ |
| (HDPE) | and a melt index (I₂) of 57 |
| | Alathon H5057 from Equistar Corporation |
| Oxidized Low Density | Oxidized low density polyethylene having a density |
| Polyethylene (Oxidized LDPE) | of 0.93 g/cm³ |
| | A-C 629A from Honeywell Corporation |
| Oxidized High Density | Oxidized high density polyethylene having a density |
| Polyethylene | of 0.98 g/cm³ |
| (Oxidized HDPE) | A-C 316A from Honeywell Corporation |
| Ultra High MW PDMS in | Masterbatch of ultra high molecular weight |
| HDPE | functionalized poly(dimethylsiloxane) (PDMS) (50 wt |
| | %) in high density polyethylene with a melt index |
| | (I₂) of 57 |
| | MB50-314 From Dow Corning |
| High Density Polyethylene 2 | Dispersion of high density polyethylene with 35% |
| (HDPE 2) | solids with a non-ionic surfactant |
| | Michem ® Emulsion 98635 from Michelman, Inc. |
| High Density Polyethylene 3 | Dispersion of high density polyethylene with 35% |
| (HDPE 3) | solids with an anionic surfactant |
| | Michem ® Emulsion 61335 from Michelman, Inc. |

Dry Blending

Each of the dry blends are made in either a 5 pound Prodex high intensity blender or a 50 lb Welex 35M high intensity blender. The blends prepared using the Prodex blender are used for the 2-roll mill metal adhesion testing discussed below. The blends prepared using the Welex 35M blender are used for the extrusion testing discussed below.

2.5″ Egan Extrusion

Certain blends (as noted below) are extruded using a 2.5″ Egan single screw extruder with a J screw and 6″ annular die. The temperature profile used is shown in Table 2.

TABLE 2

| Zones | Set points (° C.) |
|---|---|
| Feedthroat | 24 |
| Barrel zone #1 | 138 |
| Barrel zone #2 | 146 |
| Barrel zone #3 | 154 |
| Clamp Temp. | 163 |
| Adapter Temp | 163 |
| Steam Die Temp | 163 |

The effects of different extrusion rates are evaluated by varying the extruder screw speed.

Multilayer Film Preparation

Multilayer films are coextruded using a blown film line. The nominal thickness is 2.5 mils. The layer distribution (a/b/c/b/a) is DOWLEX™ 2247G/Elvax 3190/PVDC-MA Polymer Composition/Elvax 3190/DOWLEX™ 2247G with corresponding percentages by volume of 35%/10%/10%/10%/35%. DOWLEX™ 2247G is a linear low density polyethylene resin commercially available from The Dow Chemical Company. Elvax 3190 is an ethylene vinyl acetate copolymer commercially available from DuPont. The PVDC-MA Polymer Composition is as specified in the example.

Metal Adhesion Testing

The 2-roll mill test apparatus consists of two counter-rotating heated metal rolls, referred to as the “primary” and “boundary” rolls. These two rolls run at slightly different rpm. In a typical test, the gap between the rolls is closed and polymer is added to the nip area between the rolls where it melts and adheres to the primary roll. The gap between the rolls can be adjusted to provide the desired thickness of resin on the primary roll. Excess polymer forms a molten polymer roll in the nip area between the rolls. As the molten polymer is mixed on the 2-roll mill, it will begin to degrade over time. The primary purpose of the 2-roll mill test is to observe this degradation and the effects of this degradation over time. Typical observed effects include discoloration, gassing and metal adhesion. Observations of metal adhesion are particularly important since it is an indication of potential metal adhesion in an extrusion operation. Metal adhesion during extrusion operation can lead to further polymer degradation and carbon formation. Degraded polymer and carbon can both adversely impact the quality of extruded films and require more frequent cleaning of the extruder and/or die.

Test conditions used for 2-roll mill testing are 180° C. roll surface temperature, 23 rpm and 200 grams of resin sample. The test is run for a total of 30 minutes from the time the resin sample is added to the 2-roll mill. Adhesion observations are made beginning at 3 minutes and every 3 minutes thereafter until 30 minutes. It is desired that the polymer sample sticks to the primary roll only. Undesirable metal adhesion is observed as polymer sticking to the boundary roll. The adhesion is quantified using a 0 to 5 scale of increasing adhesion severity as shown in Table 3. The % of the boundary roll coated with adhered polymer at 30 minutes is also recorded. The test then results in a table of adhesion rating versus time. Lower adhesion ratings for a longer time is considered superior performance. An adhesion rating of 0 through 30 minutes, meaning no adhesion, is most desired.

TABLE 3

| Rating | Observation |
|---|---|
| 0 | No polymer sticking on the boundary roll |
| 1 | Polymer sticking on boundary roll in small spots |
| 2 | Thin layer of polymer over most of boundary roll |
| 3 | Thin layer over most of boundary roll with some thick spots |
| 4 | Thick layer of polymer over most boundary roll |
| 5 | Equal amount of polymer on both rolls |

Oxygen Barrier Testing

The oxygen transmission rate of certain multilayer films is measured by a MOCON OX-TRAN® Model 2/21 oxygen transmission rate testing system at 23° C. and 50% relative humidity according to ASTM D3985.

Haze

The haze of certain multilayer films is measured by BYK Haze-O-meter according to ASTM D1003.

### Example 1

The formulations in Table 4 are prepared by dry blending of PVDC-MA Copolymer 1 (no Plastistrength L-1000) or PVDC-MA Copolymer 2 (with Plastistrength) with various additives, as specified.

TABLE 4

| | Compar. | Compar. | Compar. | Compar. | Compar. | Inv. | Inv. | Inv. |
|---|---|---|---|---|---|---|---|---|
| Formulation | Ex. 1 | Ex. 2 | Ex. 3 | Ex. 4 | Ex. 5 | Ex. 1 | Ex. 2 | Ex. 3 |
| PVDC-MA | 100.00 | | | 99.8 | 99.8 | 99.65 | 49.745 | 99.5 |
| Copolymer 2 | | | | | | | | |
| PVDC-MA | | 98 | 99.65 | | | | 49.745 | |
| Copolymer 1 | | | | | | | | |
| Acrylic Polymer | | 2 | | | | | | |
| (spray dried) | | | | | | | | |
| LDPE | | | | 0.1 | | | | |
| Oxidized LDPE | | | | 0.1 | 0.1 | | | |
| Oxidized HDPE | | | 0.25 | | | 0.25 | 0.25 | |
| Wax | | | 0.1 | | 0.1 | 0.1 | 0.1 | |
| Ultra High MW | | | | | | | 0.16 | |
| PDMS in HDPE | | | | | | | | |
| HD Polyethylene | | | | | | | | 0.5 |
| (HDPE) | | | | | | | | |

The metal adhesion testing was carried out by the two roll mill as described above. The adhesion results of various formulations are shown in Table 5.

TABLE 5

| | | | | | | | | | | Surface |
|---|---|---|---|---|---|---|---|---|---|---|
| | Amt. of | | | | | | | | | coverage |
| | Acrylic | Other | Sticking rating at different time (mins) | | | | | | | of roll |
| Sample | Polymer | additives | 12 | 15 | 18 | 21 | 24 | 27 | 30 | @ 30 mins. |
| Compar. | 2% | None | 0 | 0 | 1 | 1 | 2 | 2 | 2 | 100% |
| Ex. 1 | | | | | | | | | | |
| Compar. | 2% | None | 1 | 2 | 2 | 2 | 3 | 3 | 3 | 100% |
| Ex. 2 | | | | | | | | | | (thick |
| | | | | | | | | | | spots) |
| Compar. | 0% | 0.25% | 0 | 0 | 0 | 0 | 0 | 0 | 0 | 0 |
| Ex. 3 | | Oxidized | | | | | | | | |
| | | HDPE/ | | | | | | | | |
| | | 0.1% Wax | | | | | | | | |
| Compar. | 2% | 0.1% | 1 | 2 | 2 | 2 | 2 | 3 | 3 | 100% |
| Ex. 4 | | LDPE/ | | | | | | | | (thick |
| | | 0.1% | | | | | | | | spots) |
| | | Oxidized | | | | | | | | |
| | | LDPE | | | | | | | | |
| Compar. | 2% | 0.1% | 1 | 2 | 2 | 2 | 2 | 2 | 2 | 100% |
| Ex. 5 | | Oxidized | | | | | | | | |
| | | LDPE/ | | | | | | | | |
| | | 0.1% Wax | | | | | | | | |
| Inv. | 2% | 0.25% | 0 | 0 | 0 | 0 | 0 | 0 | 0 | 0 |
| Ex. 1 | | Oxidized | | | | | | | | |
| | | HDPE/ | | | | | | | | |
| | | 0.1% Wax | | | | | | | | |
| Inv. | 1% | 0.25% | 0 | 0 | 0 | 0 | 0 | 0 | 0 | 0 |
| Ex. 2 | | Oxidized | | | | | | | | |
| | | PE/0.1% | | | | | | | | |
| | | Wax/ | | | | | | | | |
| | | 0.16% | | | | | | | | |
| | | Ultra High | | | | | | | | |
| | | MW | | | | | | | | |
| | | PDMS in | | | | | | | | |
| | | HDPE | | | | | | | | |
| Inv. | 2% | 0.5% | 0 | 0 | 0 | 1 | 1 | 1 | 1 | 2% |
| Ex. 3 | | HDPE | | | | | | | | |

Comparative Ex. 1 only contains plasticizer (ESO) and acrylic polymer (Plastistrength L-1000) without any other additives. Comparative Ex. 1 begins to stick to the metal roll surface around 18 minutes, and then develops into a thin sticky layer on the full metal roll surface around 24 minutes. Comparative Ex. 2 has the same composition as Comparative Ex. 1 except that it is made by dry blending. Comparative Ex. 1 and Comparative Ex. 2 each exhibit significant metal adhesion at the end of 30 minutes. Comparative Ex. 3 has plasticizer (ESO) and two wax/polyolefin additives, but without acrylic polymer. Comparative Ex. 3 exhibits zero adhesion during the testing (30 minutes). However, Comparative Ex. 3 exhibits severe feeding issues during extrusion (as discussed below) due to the high loading of wax/polyolefin additives. Comparative Ex. 4 includes a low density polyethylene and an oxidized low density polyethylene. Comparative Ex. 5 includes a wax and an oxidized low density polyethylene. Comparative Ex. 4 and Comparative Ex. 5 each exhibit significant sticking. Inventive Ex. 1 to Ex. 3 comprises plasticizer (ESO), an acrylic polymer (Plastistrength L-1000), and different combinations of waxes, polyethylenes, oxidized polyethylenes and PDMS. Inventive Ex. 1 and Ex. 2 exhibit zero adhesion during the testing after 30 minutes. Inventive Ex. 3 exhibits around 2% surface sticking at the end of testing, which is significantly less than Comparative Exs. 1, 2, 4, and 5.

Certain of the formulations are also evaluated for extrusion performance using the 2.5″ Egan Extrusion test described above. The results are shown in Table 6.

TABLE 6

| | | | | | | | Max. | |
|---|---|---|---|---|---|---|---|---|
| | Amt. of | | | Screw | Output | | Melt | |
| | Acrylic | Other | Feeding | speed | Rate | Pressure | Temp. | Brown |
| Sample | Polymer | Additives | Issue? | (rpm) | (lb/hr) | (psi) | (° C.) | swirl |
| Compar. | 2% | none | no | 60 | 164 | 3924 | 210 | yes |
| Ex. 1 | | | | | | | | |
| Compar. | 0% | 0.25% | yes | | | | | |
| Ex. 3 | | Oxidized | | | | | | |
| | | HDPE/0.1% | | | | | | |
| | | Wax | | | | | | |
| Inv. | 2% | 0.25% | no | 65 | 167 | 3804 | 205 | no |
| Ex. 1 | | Oxidized | | | | | | |
| | | HDPE/0.1% | | | | | | |
| | | Wax | | | | | | |
| Inv. | 1% | 0.25% | no | 64.7 | 163 | 3886 | 205 | no |
| Ex. 2 | | Oxidized | | | | | | |
| | | HDPE/0.1% | | | | | | |
| | | Wax/0.16% | | | | | | |
| | | Ultra High | | | | | | |
| | | MW PDMS | | | | | | |
| | | in HDPE | | | | | | |

Comparative Ex. 3 exhibits severe feeding issues and could not be extruded consistently. Comparative Ex. 1 has the highest pressure (3924 psi) and melt temperature (around 210° C.). Some brown swirl was also observed in the film formed from Comparative Ex. 1, indicating some degradation occurred during extrusion. At the same output rate, Inventive Ex. 1 and Inventive Ex. 2 have lower pressure and melt temperature than Comparative Ex. 1. Brown swirl is not observed either. Overall, Inventive Ex. 1 and Ex 2 have improved thermal stability and extrusion performance.

Multilayer films are prepared as described above using Comparative Ex. 1 and Inventive Ex. 1 as the PVDC-MA Polymer Composition. The multilayer films are tested for oxygen transmission rate and haze, and the results are provided in Table 7.

TABLE 7

| | | | Multi- | | Oxygen | |
|---|---|---|---|---|---|---|
| | Amt. of | | layer Film | Vol % | Transmission Rate | |
| | Acrylic | Other | Thickness | PVDC- | (cc/100 in²-day- | |
| Sample | Polymer | Additives | (mil) | MA layer | atm) | Haze |
| Compar. | 2% | none | 2.575 | 10.2 | 0.635 | 18 |
| Ex. 1 | | | | | | |
| Inv. | 2% | 0.25% | 2.585 | 10.8 | 0.649 | 19 |
| Ex. 1 | | Oxidized | | | | |
| | | HDPE/ | | | | |
| | | 0.1% Wax | | | | |

The oxygen transmission rate and haze values for the multilayer film made using Inventive Ex. 1 is similar to the multilayer film made using Comparative Ex. 1, indicating that the inclusion of the polyethylene and the wax in Inventive Ex. 1 did not have an adverse effect on these barrier and optical properties of the film.

### Example 2

Additional formulations are prepared as set forth in Table 8. Example 2 is used to illustrate the benefits of some embodiments of methods of the present invention. As such, “Inventive Ex.” refers to a formulation made using embodiments of an inventive method, and “Compar. Ex.” or “Comparative Ex.” refers to formulations made using other methods.

In Table 8, Inventive Exs. 4 and 5 are prepared by an embodiment of a method of the present invention. That is, a dispersion of high density polyethylene (HDPE 2 or HDPE 3) is added directly into the PVDC-MA copolymer slurry (PVDC-MA Copolymer 1) followed by addition of the Acrylic Polymer latex (Plastistrength L-1000), and then followed by coagulation with a sodium chloride (NaCl) brine solution. Inventive Ex. 6 is prepared by direct addition of solid powders of the Wax and Oxidized HDPE into the PVDC-MA copolymer slurry (PVDC-MA Copolymer 1) followed by addition of the Acrylic Polymer latex (Plastistrength L-1000), and then followed by coagulation/flocculation with NaCl brine solution, as described in WO 2013/048747 A1. Comparative Ex. 6 is prepared by coagulation of the Acrylic Polymer latex (Plastistrength L-1000) with NaCl brine solution but without wax or polyolefin dispersions, as described in U.S. Pat. No. 6,627,679.

TABLE 8

| | Compar. | Inv. | Inv. | Inv. |
|---|---|---|---|---|
| Formulation | Ex. 7 | Ex. 4 | Ex. 5 | Ex. 6 |
| PVDC-MA | 98 | 97.5 | 97.5 | 97.65 |
| Copolymer 1 | | | | |
| Acrylic Polymer | 2 | 2 | 2 | 2 |
| (latex) | | | | |
| HDPE 2 | | 0.5 | | |
| HDPE 3 | | | 0.5 | |
| Oxidized HDPE | | | | 0.25 |
| Wax | | | | 0.1 |
| Wax/Polyolefin | In slurry | No wax or | In slurry | In slurry |
| Addition Process | addition | PE | addition of | addition of |
| | of solid | additions | dispersions | dispersions |
| | powder | | | |

### Inventive Ex. 4

700 grams of vinylidene chloride copolymer resin (PVDC-MA Copolymer 1) and 874 grams of deionized (DI) water are added to a 2000 ml beaker. The mixture is stirred with a magnetic stirrer at 350 rpm. 54 grams of solution hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 10.26 grams of the HDPE 2 dispersion (35 wt % solids) is added and allowed to mix for 5 minutes. Then, 37.4 grams of the Acrylic Polymer latex (39.3 wt % solids) is added in the mixture and allowed to mix for 5 minutes. 65.1 grams of NaCl brine solution (21.3 wt %) is slowly added in the mixture over 5 minutes to coagulate the Acrylic Polymer latex and the HDPE 2 dispersion, and then allowed to mix for 5 minutes. The mixture is cooled down to 30° C. and then dewatered and dried at 75° C. for 18 hrs.

In the preparation of Inventive Ex. 4, the HDPE 2 dispersion is directly added into the PVDC-MA copolymer slurry and efficiently dispersed/mixed. All of the HDPE 2 and Acrylic Polymer are effectively coagulated by the NaCl brine solution as indicated by a clear water phase after coagulation.

### Inventive Ex. 5

700 grams of vinylidene chloride copolymer resin (PVDC-MA Copolymer 1) and 874 grams of deionized (DI) water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 10.15 grams of the HDPE 3 dispersion (35.4 wt % solids) is added and allowed to mix for 5 minutes. Then, 37.4 grams of the Acrylic Polymer latex (39.3 wt % solids) is added in the mixture and allowed to mix for 5 minutes. 65.1 grams of NaCl brine solution (21.3 wt %) is slowly added in the mixture over 5 minutes to coagulate the Acrylic Polymer latex and the HDPE 3 dispersion, and then allowed to mix for 5 minutes. The mixture is cooled down to 30° C. and then dewatered and dried at 75° C. for 18 hrs.

In the preparation of Inventive Ex. 5, the HDPE 3 dispersion is directly added into the PVDC-MA copolymer slurry and efficiently dispersed/mixed. All of the HDPE 3 and Acrylic Polymer are effectively coagulated by the NaCl brine solution as indicated by a clear water phase after coagulation.

### Inventive Ex. 6

700 grams of vinylidene chloride copolymer resin (PVDC-MA Copolymer 1) and 874 grams of DI water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 1.793 grams of the Oxidized HDPE (solid powder) and 0.717 g of the Wax (solid powder) are added. The agitation speed is increased to 500 rpm and allowed to mix for 10 minutes. Then, 37.4 grams of the Acrylic Polymer latex (39.3 wt % solid) is added in the mixture and allowed to mix for 5 minutes. 65.1 grams of NaCl Brine solution (21.3 wt %) is slowly added in the mixture over 5 minutes to coagulate the Acrylic Polymer latex and allowed to mix for 5 minutes. The mixture is cooled down to 30° C. and then dewatered and dried at 75° C. for 18 hrs.

### Comparative Ex. 6

700 grams of vinylidene chloride copolymer resin (PVDC-MA Copolymer 1) and 874 grams of DI water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 37.4 grams of the Acrylic Polymer latex (39.3 wt % solid) is added in the mixture and allowed to mix for 5 minutes. 65.1 grams of NaCl Brine solution (21.3 wt %) is slowly added in the mixture in 5 minutes to coagulate the Acrylic Polymer latex and allowed to mix for 5 minutes. The mixture is cooled down to 30° C. and then dewatered and dried at 75° C. for 18 hrs. Comparative Ex. 6 only includes the Acrylic Polymer latex, but no polyethylene or wax additives.

Metal adhesion testing is carried out on Comparative Ex. 6 and Inventive Exs. 4-6 by the two roll mill as described above. The adhesion results of the formulations are shown in Table 9.

TABLE 9

| | | | | | | | | | Surface |
|---|---|---|---|---|---|---|---|---|---|
| | | Sticking rating at | | | | | | | coverage |
| | | different time (mins) | | | | | | | of roll |
| Sample | Additives | 12 | 15 | 18 | 21 | 24 | 27 | 30 | @ 30 mins. |
| Compar. | None | 1 | 2 | 3 | 3 | 3 | 3 | 3 | 100% |
| Ex. 6 | | | | | | | | | (thick |
| | | | | | | | | | spots) |
| Inventive | 0.5% | 0 | 0 | 0 | 0 | 0 | 0 | 0 | 0 |
| Ex. 4 | HDPE 2 | | | | | | | | |
| Inventive | 0.5% | 0 | 0 | 0 | 0 | 0 | 0 | 0 | 0 |
| Ex. 5 | HDPE 3 | | | | | | | | |
| Inventive | 0.25% | 0 | 0 | 0 | 0 | 0 | 0 | 0 | 0 |
| Ex. 6 | Oxidized | | | | | | | | |
| | HDPE; | | | | | | | | |
| | 0.1% Wax | | | | | | | | |

Inventive Exs. 4-6 do not exhibit any metal adhesion when the test is completed at the end of 30 minutes. Comparative Ex. 6 starts to stick to the metal surface around 12 minutes. A thin layer of degraded VDC-MA copolymer fully covered the metal roll surface around 15 minutes and continued to build up with time. This suggests that the effective addition of HDPE by this embodiment of the inventive process can significantly reduce the metal adhesion and thus improve the VDC-MA copolymer thermal stability during extrusion.

Comparative Ex. 7, Inventive Ex. 7, and Inventive Ex. 8 are similar in processes to Comparative Ex. 6, Inventive Ex. 4, and Inventive Ex. 5, respectively, except they are prepared in a larger vessel.

### Comparative Ex. 7

13000 grams of vinylidene chloride copolymer resin (PVDC-MA Copolymer 1) is added to a 10 gallon Pfaudler reactor vessel. A mixture of 16225 grams DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 88° C. 695 grams of the Acrylic Polymer latex (39.3 wt % solid) is added and the mixture allowed to mix for 5 minutes. 1226 grams of NaCl Brine solution (21.0 wt %) is slowly added to the mixture over 5 minutes to coagulate the Acrylic Polymer latex and then allowed to mix for 5 minutes. The mixture is cooled down to 30° C., dewatered using a basket centrifuge, and dried at 70° C. for 24 hrs.

### Inventive Ex. 7

13000 grams of vinylidene chloride copolymer resin (PVDC-MA Copolymer 1) is added to a 10 gallon Pfaudler reactor vessel. A mixture of 16225 grams of DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 90° C. 189 grams of HDPE 2 dispersion (35.2 wt % solids) is added and allowed to mix for 5 minutes. Then, 695 grams of the Acrylic Polymer latex (39.3 wt % solid) is added in the mixture and allowed to mix for 5 minutes. 1226 grams of NaCl Brine solution (21.0 wt %) is slowly added to the mixture over 5 minutes to coagulate the Acrylic Polymer latex and the HDPE 2 dispersion and then allowed to mix for 5 minutes. The mixture is cooled down to 30° C., dewatered using a basket centrifuge, and dried at 70° C. for 24 hrs.

### Inventive Ex. 8

13000 grams of vinylidene chloride copolymer resin (PVDC-MA Copolymer 1) is added to a 10 gallon Pfaudler reactor vessel. A mixture of 16225 grams of DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 90° C. 191 grams of HDPE 3 dispersion (35.4 wt % solids) is added and allowed to mix for 5 minutes. Then, 728 grams of the Acrylic Polymer latex (37.5 wt % solid) is added in the mixture and allowed to mix for 5 minutes. 1210 grams of NaCl Brine solution (21.3 wt %) is slowly added to the mixture over 5 minutes to coagulate the Acrylic Polymer latex and the HDPE 3 dispersion and allowed to mix for 5 minutes. The mixture is cooled down to 30° C., dewatered using a basket centrifuge, and dried at 70° C. for 24 hrs.

Backscatter electron images of the resins produced in Comparative Ex. 7, Inventive Ex. 7, and Inventive Ex. 8 using a scanning electron microscope (SEM) following the procedures described in: Clifford S. Todd and Douglas E. Beyer, “Characterization of the Thickness and Distribution of Latex Coatings on Polyvinylidene Chloride Beads by Backscattered Electron Imaging,” Microscopy and Microanalysis, Vol. 21, Issue 02, pp. 472-479 (April 2015) show that the coagulated additives (Acrylic Polymer latex, HDPE 2, and HDPE 3) are evenly distributed on the surface of the vinylidene chloride/methyl acrylate copolymer beads.

Metal adhesion testing is carried out on Comparative Ex. 7 and Inventive Exs. 7 and 8 by the two roll mill as described above. The adhesion results of the formulations are shown in Table 10.

TABLE 10

| | | | | | | | | | Surface |
|---|---|---|---|---|---|---|---|---|---|
| | | Sticking rating at | | | | | | | coverage |
| | | different time (mins) | | | | | | | of roll |
| Sample | Additives | 12 | 15 | 18 | 21 | 24 | 27 | 30 | @ 30 mins. |
| Compar. | None | 2 | 2 | 2 | 2 | 3 | 4 | 4 | 100% |
| Ex. 7 | | | | | | | | | (thick |
| | | | | | | | | | spots) |
| Inventive | 0.5% | 0 | 0 | 0 | 0 | 0 | 0 | 0 | 0 |
| Ex. 7 | HDPE 2 | | | | | | | | |
| Inventive | 0.5% | 0 | 0 | 0 | 0 | 0 | 0 | 0 | 0 |
| Ex. 8 | HDPE 3 | | | | | | | | |

1. A vinylidene chloride polymer composition comprising (a) a vinylidene chloride polymer formed from a monomer mixture comprising from 60 to 99 weight percent vinylidene chloride monomer and from 40 to 1 weight percent of a monoethylenically unsaturated monomer copolymerizable therewith; (b) 0.3 to 5 weight percent of an acrylic polymer based on the total weight of the polymer composition; and (c) 0.2 to 7 weight percent of at least one additive comprising (i) at least one wax in an amount of from 0.01 to 2 weight percent based on the total weight of the polymer composition, (ii) at least one polyethylene having a density greater than 0.940 g/cm³ in an amount of from 0.1 to 5 weight percent based on the total weight of the polymer composition, or combinations thereof.

2. The composition of claim 1, wherein the monoethylenically unsaturated monomer comprises vinyl chloride, alkyl acrylate, alkyl methacrylate, acrylic acid, methacrylic acid, itaconic acid, acrylonitrile, methacrylonitrile, or a combination thereof.

3. The composition of claim 1, wherein the monoethylenically unsaturated monomer comprises methyl acrylate.

4. The polymer composition of claim 1, wherein the acrylic polymer comprises monomer units of at least one of alkyl acrylate, alkyl methacrylate, styrenic monomer, or a combination thereof.

5. The polymer composition of claim 4, wherein the acrylic polymer comprises monomer units derived from butyl acrylate, butyl methacrylate, or methyl methacrylate.

6. The polymer composition of claim 1, wherein the composition comprises 0.5 to 3 weight percent of the acrylic polymer.

7. The polymer composition of claim 1, wherein the at least one additive comprises Fischer-Tropsch paraffin wax.

8. The polymer of composition of claim 1, wherein the wax has a molecular weight at least 500 and a melting point at least 70° C.

9. The polymer composition of claim 1, wherein the wax is oxidized.

10. The polymer composition of claim 1, wherein the polyethylene is oxidized.

11. The polymer composition of claim 1, wherein the total amount of wax and polyethylene comprises 0.01 to 5 weight percent of the total weight of the polymer composition.

12. The polymer composition of claim 1, further comprising at least one plasticizer, wherein the at least one plasticizer comprises epoxidized soybean oil, epoxidized linseed oil, epoxidized esters, dibutyl sebacate, acetyl tributyl citrate, a citrate ester, a polymeric ester oil, a high molecular weight ester oil, or a combination thereof.

13. The polymer composition of claim 12, wherein the composition comprises 0.1 to 10 weight percent of the plasticizer.

14. The polymer composition of claim 1, wherein the vinylidene chloride polymer is in the form of particles, and wherein at least one of the acrylic polymer, wax, or polyethylene is coagulated on the surface of the vinylidene chloride polymer particles.

15. An article formed from the polymer composition of claim 1.
